(19) United States
(12) Patent Application Publication
(10) Pub. No.: US 2006/0078472 A1
(43) Pub. Date: Apr. 13, 2006

(54) Microchannel chip system and detection chip

(75) Inventors: Masayoshi Momiyama, Handa-shi (JP); Yuji Iwata, Ichinomiya-shi (JP); Takashi Kawano, Anjo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi, JP (US)

(21) Appl. No.: 11/221,944

(22) Filed: Sep. 9, 2005

(30) Foreign Application Priority Data
Sep. 28, 2004 (JP) 2004-282296

(51) Int. Cl. B01L 3/00

(52) U.S. Cl. 422/100

(57) ABSTRACT

A microchannel chip system and a detection chip capable of improving detection precision are provided. The detection chip 1 of the microchannel chip system comprises a carrier retention section 13 capable of retaining a carrier supporting a second chemical substance which generates a signal by reacting with a first chemical substance and a microchannel flow channel 10 provided with a supply flow channel 14 which supplies a liquid material containing the first chemical substance to the carrier retention section 13. A carrier mobilization means (a protrusion 2) is provided for enhancing of the reactivity of the second chemical substance supported in the carrier 9 with the first chemical substance contained in the liquid material by moving the carrier retained in the detection chip 1.

### CROSS REFERENCE TO RELATED APPLICATIONS

This application is based on and claims priority under 35 U.S.C. § 119 to Japanese Patent Application 2004-282296, filed on Sep. 28, 2004, the entire content of which is incorporated herein by reference.

### BACKGROUND OF THE INVENTION

1. Field of the Invention

The present invention relates to a microchannel chip system and a detection chip, wherein the microchannel chip system generates signals by reacting a liquid material containing a first chemical substance with a second chemical substance supported on a carrier on the detection chip.

2. Description of Related Art

In the midst of public debates on environmental degradation, effects of environmental load substances such as dioxin family to organisms are feared, and a simple method for measuring these substances is desired for preventing of contamination damages of the environment, foods or the like due to these chemical substances and for handling of these appropriately. Non-patent document 1 discloses one method for determining such environmental contamination substances. This methodis pointed out to have very distinct bioconcentration properties, wherein a microflow-type detection chip with a monoclonal antibody specific to coplanar polychlorinated biphenyls is used. Furthermore, since substances to be measured have low molecular weights, a competitive method is adopted for quantitative measurements and an enzyme immunoassay is performed on a detection chip.

FIG. 12 shows the detection chip described above. FIG. 13 shows the principle of measurement. For a measurement, at first, a detection chip 100 is used in which a predetermined number of micro beads can be placed in a flow channel 101. The flow channel 101 arranged in the detection chip 100, for example, has a depth of 100 micrometers and a flow path width of 1,000 micrometers. As a carrier, a polystyrene bead 200 with a diameter of 90 micrometers is supplied into the flow channel 101. The polystyrene bead 200 is an antibody-immobilized bead on the surface of which a specific antibody 201 is attached. As shown in FIG. 13(a), in the flow channel 101, there is formed a stopper 102 which can localize the antibody-immobilized bead 200. In the detection chip 100 described above, a flow channel is designed such that a liquid containing the antibody-immobilized bead 200 can be arranged to be flowed by using a syringe pump.

After a plurality of antibody-immobilized beads 200 are supplied into the flow channel 101, as shown in FIG. 13(a), they are stopped by the stopper 102 and kept under a localized condition. Next, a liquid material 213 containing a target object substance 211 and an enzyme marker competition substance 212 is poured into the flow channel 101, as shown in FIG. 13(b). The object substance 211 and the enzyme marker competition substance 212, which have been poured simultaneously, compete each other and adhere to the antibody 201 of the antibody-immobilized bead 200 by an antigen-antibody reaction, as shown in FIG. 13(c). And then, the enzyme marker competition substance adhered to a non-specific location is washed out by washing treatment. Then, as shown in FIG. 13(d), after a fluorescent substrate 220 is poured into the flow channel 101, excitation light is irradiated on the antibody-immobilized bead 200. Then, fluorescent light from the enzyme marker competition substance 212 is detected by a fluorescent microscope and thus a quantitative measurement of the object substance 211 is performed comparatively.

Here, FIG. 14 shows schematically the configuration of the fluorescent microscope. As shown in FIG. 14, the fluorescent microscope 1200 comprises collimator lenses 1220 and 1230 which collimate the excitation light illuminated from a light source 1210 and an excitation filter 1240 which extracts a necessary wavelength component from the excitation light. On the other hand, at the upstream side of the detection chip 100, an object lens 1250 composed of a plurality of lens groups is arranged, and at the further upstream side, there are arranged a dichroic mirror 1260 which splits the light from the light source 1210 for irradiation to the antibody-immobilized bead 200 and for imaging of the antibody-immobilized bead 200, an absorption filter 1270 which absorbs an excitation light component, an imaging lens 1280 consisting of a group comprising 2 to 3 lenses, and a cooledg CCD 1290 capable of high sensitivity imagery.

Non-patent document 1: Eiichi Tamiya, ‘Development of a microflow-type biosensor using MEMS technology,’ Surface Technology 32-36, No. 10, 2003, Surface Technology Society.

### SUMMARY OF THE INVENTION

According to the technology described above, it is possible to provide a microchannel chip system in which a quantitative measurement of an object substance 211 can be comparatively performed by using an antigen-antibody reaction.

However, an antibody-immobilized bead 200 of solid phase precipitates by its own weight in a flow channel 101. For this reason, even when a liquid material 213 containing the target object substance 211 and an enzyme marker competition substance 212 is provided in the flow channel 101, there are limitations on that the liquid 213 flows thoroughly freely. Therefore, there are limitations on the homogeneity of the antigen-antibody reaction in the antibody-immobilized bead 200 and thus there are limitations on the improvement of detection accuracy.

In view of the actual situation described above, the present invention intends to provide a microchannel chip system in which improvement of detection accuracy of an object substance can be achieved.

(1) A microchannel chip system related to aspect 1 comprises a detection chip having a microchannel flow channel which is provided with a carrier retention section capable of retaining a carrier supporting a second chemical substance which generates a signal by reacting with a first chemical substance and a supply flow channel which supplies a liquid material containing a first chemical substance to the carrier retention section, and a carrier mobilization means that enhances the reactivity of the first chemical substance contained in the liquid material with the second chemical substance supported by the carrier by moving the carrier retained in the carrier retention section.

The carrier mobilization means moves the carrier retained in the carrier retention section. For this reason, the reactivity of the second chemical substance supported by the carrier with the first chemical substance contained in the liquid can be enhanced. Thus, since the reactivity is enhanced, the detection accuracy is improved.

(2) A microchannel chip system related to aspect 2 comprises a detection chip having a microchannel flow channel which is provided with a carrier retention section capable of retaining a carrier supporting a second chemical substance which generates a signal by reacting with a first chemical substance, and a supply flow channel which supplies a liquid material containing a first chemical substance to the carrier retention section, and a carrier mobilization means that enhances the reactivity of the first chemical substance contained in the liquid material with the second chemical substance supported by the carrier by moving the carrier retained in the carrier retention section, and a signal detection means that detects a signal generated from the carrier retained in the carrier retention section.

The carrier mobilization means moves the carrier retained in the carrier retention section. For this reason, the reactivity of the second chemical substance supported by the carrier with the first chemical substance contained in the liquid can be enhanced. And then, the signal detection means detects a signal generated from the carrier retained in the carrier retention section. Thus, since the reactivity is enhanced, the detection accuracy is improved.

(3) A detection chip related to aspect is a detection chip having a microchannel flow channel which is provided with a carrier retention section capable of retaining a carrier supporting a second chemical substance which generates a signal by reacting with a first chemical substance and a supply flow channel which supplies a liquid material containing the first chemical substance to the carrier retention section, wherein the detection chip comprises a carrier mobilization means that enhances the reactivity of the first chemical substance contained in the liquid material with the second chemical substance supported by the carrier by moving the carrier retained in the carrier retention section.

Via the carrier mobilization means with a finger tip of a user or an actuator, the carrier retained in the detection chip is moved. For this reason, the reactivity of the second chemical substance supported in the carrier with the first chemical substance contained in the liquid material is enhanced.

Thereafter, the signal detection means detects the signal generated from the carrier retained in the detection chip. Thus, since the reactivity is enhanced, the detection accuracy is improved.

According to the microchannel chip system and the detection chip of the present invention, the contact between the second chemical substance supported in the carrier and the first chemical substance contained in the liquid material can be enhanced. As a result, the reactivity can be enhanced. Therefore, the detection accuracy of the signal can be improved.

### BRIEF DESCRIPTION OF THE DRAWINGS

FIG. 1 shows a perspective view of a first substrate and a second substrate of a detection chip.

FIG. 2 is a plan view showing schematically a carrier retention section formed in the detection chip.

FIG. 3 is a configuration diagram showing schematically the detection chip.

FIG. 4 shows a configuration diagram when fluorescence intensity is measured by a fluorescence intensity detector.

FIG. 5 is a backside diagram showing a Fresnel lens provided in the detection chip.

FIG. 6 shows a configuration diagram when fluorescence intensity is measured by the fluorescence intensity detector.

FIG. 7 shows a configuration diagram when fluorescence intensity is measured by the fluorescence intensity detector.

FIG. 8 is a plan view showing schematically a mechanism to rotate a detection chip according to Embodiment 2.

FIG. 9 is a plan view showing schematically a mechanism to rotate a detection chip installed on a holder according to Embodiment 3.

FIG. 10 is a sectional view showing schematically a mechanism to move a carrier retained in a detection chip according to Embodiment 4.

FIG. 11 is a plan view showing schematically a mechanism to move a carrier retained in a detection chip according to Embodiment 5.

FIG. 12 is a perspective view of the detection chip.

FIG. 13 is a configuration diagram showing the principle of measurement.

FIG. 14 is a configuration diagram showing a fluorescence microscope.

### DETAILED DESCRIPTION OF PREFERRED EMBODIMENTS

A microchannel chip system according to the present invention comprises a detection chip, which can retain a carrier, and a carrier mobilization means, which can enhance the reactivity of a second chemical substance supported on the carrier with a first chemical substance contained in a liquid material by moving the carrier retained in a carrier retention section.

The first chemical substance and the second chemical substance include, for example, antibodies and antigens which contribute to immunological reactions, biocatalysts such as enzymes, proteins such as receptors or binding proteins, organelles in which proteins are highly assembled, microorganisms, animal and plant cells, animal and plant cell tissues, DNAs, or the like. Therefore, reactions of the first chemical substance and the second chemical substance include, for example, antigen-antibody reactions, substrate-enzyme reactions, hormone-receptor reactions, DNA hybridization reactions which bond DNA to DNA, or the like.

The detection chip is provided with a microchannel flow channel. The microchannel flow channel comprises a carrier retention section capable of retaining a carrier supporting the second chemical substance which generates a signal by reacting with the first chemical substance and a supply flow channel which supplies the liquid containing the first chemical substance to the carrier retention section. The carrier includes, for example, at least one selected from a group consisting of resin, ceramics (such as alumina), charcoal, clay, cellulose, silica gel, glass, collagen, and the like. The carrier can preferably be placed in the microchannel flow channel of the detection chip.

The flow channel width of the microchannel flow channel is infinitesimal and can be chosen to be, for example, 1 to 2,000 micrometers, 100 to 1,500 micrometers, or 20 to 1,000 micrometers. Furthermore, it can be chosen to be 40 to 500 micrometers or 50 to 150 micrometers, but it is not limited to these.

A signal detection means can be adopted from embodiments which detect at least one kind selected from optical signals, magnetic signals, electrical signals, thermal signals, or the like generated from the carrier retained in the detection chip. The optical signals may include, for example, color change, light absorption, light attenuation and the like. In the case of fluorescent signals, it is possible to adopt an embodiment which can detect at least one kind among fluorescent intensity, fluorescent spectrum, and fluorescent life time.

The carrier mobilization means can be adopted from embodiments in which a protrusion portion is provided at the detection chip or at a holder. It is preferable that the protrusion portion protrudes toward the external direction from the detection chip or the holder so that a user can operate with his or her finger tip. Via the protrusion portion formed at the detection chip, it is possible to move (including rotation and swing motion) the detection chip. Furthermore, in case the protrusion portion is not provided for the detection chip, the detection chip can be moved (including rotational motion, rotation, and swing motion) via the protrusion portion provided for the holder holding the detection chip.

The carrier mobilization means can be adopted from embodiments in which an actuator is provided to move the detection chip or the holder holding the detection chip. It is preferable that the actuator can be exemplified by motor mechanism. The motor mechanism can be a rotary motor, a linear motor, or an ultrasonic motor.

During movement of the detection chip, it is possible to select a method to rotate the detection chip continuously in one direction, or a method to swing the detection chip in one direction and in the other direction without completing a full turn. When the detection chip is rotated, the following situation is taken into consideration, and the rotational speed can be, for example, 0.1 to 300 rpm, 0.5 to 100 rpm, 1.5 to 80 rpm, or 5 to 50 rpm, but it is not limited to these. When the movement speed is excessively slow, damage of the detection chip, scattering of the liquid, or the like may be caused.

The carrier mobilization means can be adopted from embodiments in which a liquid means moves the carrier retained in the carrier retention section by kinetic energy of the liquid. The liquid means can be adopted from embodiments in which the carrier retained in the carrier retention section is moved in a release flow channel by releasing the liquid to the carrier retention section capable of retaining the carrier. This arrangement allows to prevent the carrier from precipitating by its own weight.

The carrier mobilization means can be adopted from embodiments in which a magnetic field generating means moves the carrier retained in the carrier retention section with magnetic energy. In this case, the carrier can be made of magnetic materials or can be a core made of magnetic materials coated with coating materials such as resins. The magnetic field generating means can be a permanent magnet or an electromagnet. Since the carrier is moved with magnetic energy as described above, the carrier is prevented from precipitating by its own weight

In addition, in order to remove an unreacted substance after a reaction between the first chemical substance and the second chemical substance is carried out, it is preferable to perform washing treatment for the carrier retained in the detection chip. In the case of the washing treatment, by flowing a liquid material such as a buffer solution in the supply flow channel of the microchannel flow channel after the reaction between the first chemical substance and the second chemical substance is carried out, it is possible to remove the unreacted substance remaining at the carrier retention section by washing. In the case of the washing treatment, it is preferable to move the carrier retained in the detector chip. The velocity of the detector chip is assumed to be V1 when the reaction between the first chemical substance and the second chemical substance is carried out and V2 during the washing treatment. Then, it is preferable that V1 is slower than V2, that is, that V2 is faster than V1 (V2>V1). It is possible to have V2/V1=1.1 to 70, or 1.1 to 50. Since V1 is slower than V2, it is possible to maintain the reactivity between the first chemical substance and the second chemical substance. In addition, since V2 is faster than V1, it is possible to remove the unreacted substance adequately by washing.

According to the present invention, the signal detection means can be exemplified by an embodiment in which a fluorescence intensity detector detects fluorescence intensity by irradiating excitation light on the carrier and then by collecting fluorescent light emitted after excitation with the excitation light. In this case, it is preferable that the detection chip is made of a light transmittance base material which transmits the excitation light and the fluorescent light. The fluorescence intensity detector described above is preferably adopted from embodiments in which the fluorescence intensity detector comprises a light collection means which collects the fluorescent light emitted after excitation with the excitation light, a fluorescence detector which detects the fluorescence intensity collected by the light collection means, and an excited light source which is arranged so as to irradiate the excitation light to the carrier retained in the carrier retention section of the detection chip. The detection chip is exemplified by an embodiment which has a Fresnel lens system as part of the light collection means described above. The excitation light source is preferably a laser light source. Since the laser light source has a narrow width of wavelength distribution and a high light power density, and thus it is appropriate as a light source.

In addition, the detection chip can be adopted from embodiments in which a first substrate and a second substrate, made of the light transmittance base material which transmits the excitation light and the fluorescent light, are superposed. In this case, the embodiment can be adopted in which the first substrate has the carrier retention section and the supply flow channel on one side and the Fresnel lens on the other side. Since the first substrate has the Fresnel lens, it is advantageous with respect to the proximity of the Fresnel lens to the carrier retained in the detection chip, reduction of the number of components, and saving of space.

According to the present invention, for example, the carrier mobilization means can be integrated into the signal detection means which includes the fluorescence intensity detector and the like. Or, the signal detection means, which includes the fluorescence intensity detector and the like, and the carrier mobilization means can be installed separately.

### Embodiment 1

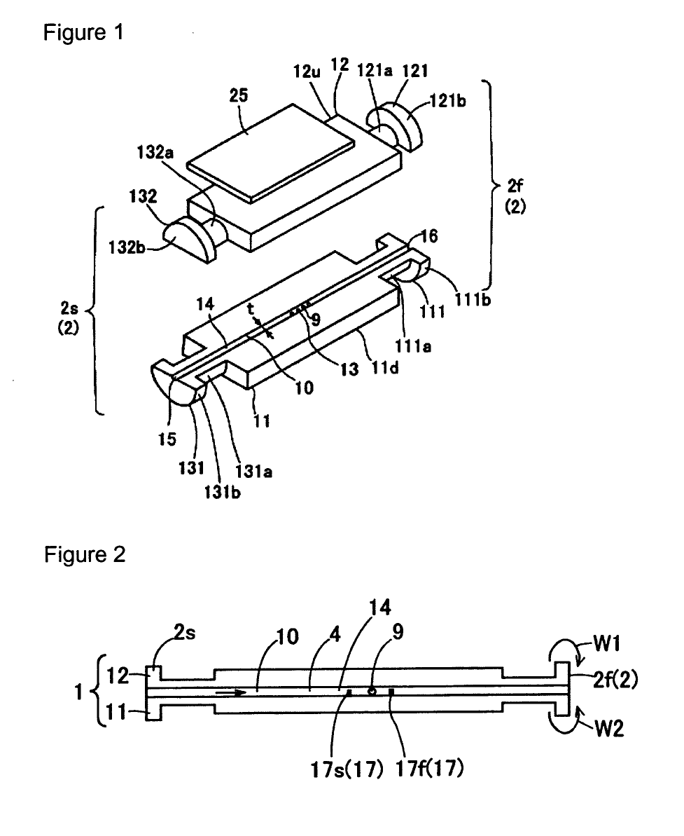

Embodiment 1 of the present invention will be explained with reference to FIG. 1 to FIG. 5. In a microchannel chip system according to the present embodiment, as shown in FIG. 1, a detection chip 1 is provided with a microchannel flow channel 10. The microchannel flow channel 10 comprises a carrier retention section 13 capable of retaining a carrier 9 supporting an antibody (a second chemical substance) which generates a signal by reacting with an antigen (a first chemical substance) and a supply flow channel 14 which supplies a buffer solution (liquid material) containing the antigen (the first chemical substance) to the carrier retention section 13.

The flow channel width of the microchannel flow channel 10, t, is infinitesimal, varies depending on the size of the carrier 9, and can be selected to be, for example, 1 to 500 micrometers, 5 to 300 micrometers, or 50 to 150 micrometers, but it is not limited to these.

Furthermore, it will be explained. The detection chip 1 is constituted by superposing a first substrate 11 formed at the bottom side and a second substrate 12 capable to function as a cover member at the top side, which are made of a light transmittance base material which transmits excitation light and fluorescent light. The first substrate 11 and the second substrate 12 are made of the light transmittance base material which transmits the excitation light and the fluorescent light. As the light transmittance base material, light transmittable and injection moldable resins (for example, acrylic resin) can be adopted. Furthermore, inorganic glass may be adopted.

As shown in FIG. 1, on one side, that is, on the top surface side of the first substrate 11, the canaliform microchannel flow channel 10 is formed. The microchannel flow channel 10 comprises a flow inlet section 15 formed at the upstream side of the supply flow channel 14 and a flow outlet section 16 formed at the downstream side of the supply flow channel 14 as well as the carrier retention section 13 and the supply flow channel 14. As shown in FIG. 2, the carrier retention section 13 formed in the microchannel flow channel 10 is sandwiched with a stopper 17 formed on the first substrate 11. The stopper 17 comprises a first stopper 17f and a second stopper 17s, arranged with an interval therebetween in the direction of the supply flow channel 14.

As shown in FIG. 1, at both end sections of the longitudinal direction of the first substrate 11 of the detection chip 1, a protrusion 2 is formed. The protrusion 2 functions as a carrier mobilization means which moves the carrier 9 on the detection chip 1. The protrusion 2 consists of a first protrusion 2f and a second protrusion 2s which extrude axially outward, in the opposite directions each other. The first protrusion 2f and the second protrusion 2s extrude from the detection chip outward so as to be operated by user's finger tip. The first protrusion 2f consists of a portion 111 formed at one end of the first substrate 11 and a portion 121 formed at the one end of the second substrate 12. The portion 111 consists of a small radial portion 111a and a large radial portion 111b. The portion 121 consists of a small radial portion 121a and a large radial portion 121b. The large radial portions 111b and 121b are provided for easier operation by finger tip etc.

As shown in FIG. 1, the second protrusion 2s consists of a portion 131 formed at the other end of the first substrate 11 and a portion 132 formed at the other end of the second substrate 12. The portion 131 consists of a small radial portion 131a and a large radial portion 131b. The portion 132 consists of a small radial portion 132a and a large radial portion 132b. The large radial portions 131b and 132b are provided for easier operation by finger tip etc. When the first substrate 11 and the second substrate 12 are superposed, the first protrusion 2f and the second protrusion 2s are formed. Furthermore, in the condition when the first substrate 11 and the second substrate 12 are superposed, it is preferable to constrain the first substrate and the second substrate by a constrain, which is not shown. The first protrusion 2f can have the same structure and the same size as those of the second protrusion 2s. In addition, for the first protrusion 2f and the second protrusion 2s, any item among the length, diameter, and structure can be made to be different. In such arrangements having different properties, it is easy to identify the first protrusion 2f and the second protrusion 2s.

In addition, as shown in FIG. 4 and FIG. 5, a Fresnel lens 18 is provided on the bottom surface 11d side of the other surface side of the first substrate 11. Since the first substrate 11 holds the Fresnel lens 18, it is advantageous with respect to the proximity of the carrier 9 to the Fresnel lens 18, reduction of the number of components, and saving of space. On the top surface 12u of the second substrate 12 is provided a reflecting mirror 25.

The first substrate 11 and the second substrate 12, which form the detection chip 1, can be made by injection molding of resins. Thus, the detection chip 1 can be arranged to retain the carrier 9 supporting the antibody (antibody-immobilized bead) in the carrier retention section 13 of the microchannel flow channel in advance and it can be throwaway-type.

During use, a predetermined number of bead-like carriers 9 are retained in the carrier retention section 13 of the first substrate 11. The carrier 9 is made of a base material of resins such as polyethylene, but it is not limited to resins. The antibody is attached on the surface of the carrier 9 by physical bonding or chemical bonding. For this reason, the carrier 9 is called an antibody-immobilized bead. Since the position of the carrier 9 is determined by the first stopper 17f and the second stopper 17s, it does not move further to the downstream side or the upstream side and it is retained in the carrier retention section 13 of the detection chip 1. Since the first substrate 11 and the second substrate 12 are superposed, the carrier 9 is prevented from falling down from the detection chip 1.

Under this condition, a buffer solution containing the antigen is supplied to the flow inlet section 15 at the upstream side of the supply flow channel 14 of the microchannel flow channel 10 of the detection chip 1. According to this arrangement the buffer solution is flowed toward the flow outlet section 16 at the downstream side of the microchannel flow channel 10 of the detection chip 1 with a predetermined flow velocity. Thus, on the carrier 9 retained in the carrier retention section 13 of the detection chip 1, an antigen-antibody reaction is carried out. This reaction is carried out at room temperature. The flow velocity of the buffer solution is preferable to be constant and slow. Here the flow velocity is chosen depending on the carrier 9, species of the antibody, species of the antigen, the flow channel width of the microchannel flow channel 10, and the like. For example, the flow velocity of the buffer solution per minute can be 0.01 to 50 microliter/min, especially 0.11 to 10 microliter/min, but it is not limited to these.

As described above, when the antigen-antibody reaction is carried out on the carrier 9 by flowing the buffer solution toward the downstream side of the microchannel flow channel 10 of the detection chip 1, a user operates repeatedly the protrusion 2 of the detection chip 1 toward one direction (W1 arrow direction) and toward the other direction (W2 arrow direction) with his or her finger tip to induce swing motion. With this operation, the detection chip 1 is repeatedly swung alternately toward the one direction (W1 arrow direction) and toward the other direction (W2 arrow direction) by turning the protrusion 2. This activates Brownian motion in the buffer solution and thus the probability that the antigen contacts with the antibody is increased. Therefore, fluctuations of the antigen-antibody reaction are reduced and thus the efficiency of the antigen-antibody reaction is improved. Furthermore, continuous turning operation either toward the one direction (W1 arrow direction) or toward the other direction (W2 arrow direction) is also appropriate.

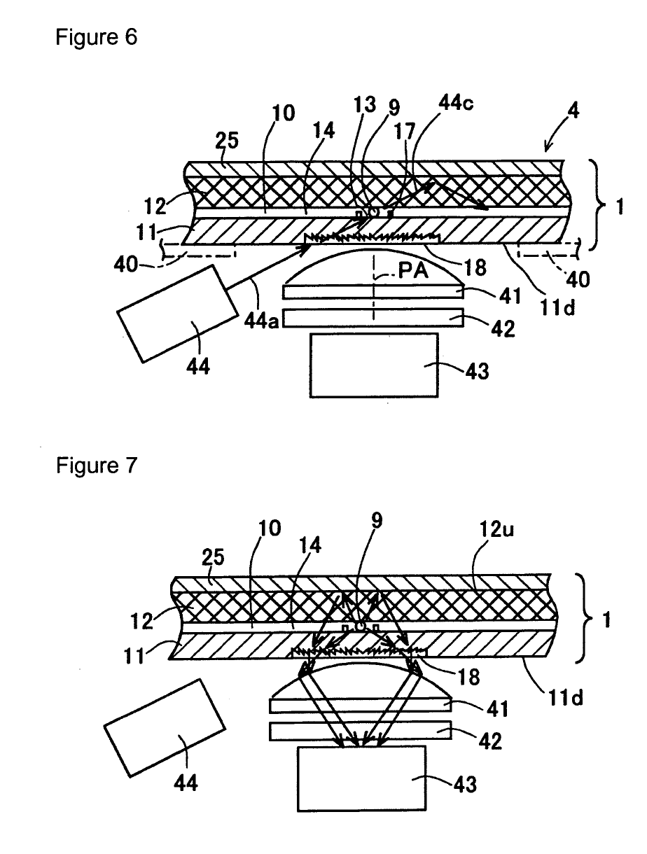

Thereafter, the detection chip 1 described above is provided for a fluorescence intensity detector 4 (with reference to FIG. 6) as a signal detection means. Then, excitation light is irradiated on the carrier 9 of the detection chip 1, and fluorescent light emitted from the carrier 9 after excitation with the excitation light is collected. Then fluorescence intensity is detected by the fluorescence intensity detector 4.

As shown in FIG. 6, the fluorescence intensity detector 4 described above comprises a holder 40 for installation of the detection chip 1, a light collection lens 41 as a light collection means to focus the fluorescent light emitted after excitation with the excitation light, a band-pass filter 42 for transmission of the fluorescent light in a predetermined wavelength range, a fluorescence detector 43 for detection of the fluorescence intensity by receiving the fluorescent light collected with the light collection lens 41, and an excitation light source 44 which is arranged to irradiate the excitation light (laser light: central wave length of 488 nm) toward the carrier 9 retained in the carrier retention section 13 of the detection chip 1.

The fluorescence detector 43 is composed of, for example, a photodiode, or a photomultiplier tube, or the like. The Fresnel lens 18 arranged at the first substrate 11 of the detection chip 1 can function as part of the light collection means together with the light collection lens 41. The excitation light source 44 is provided at a diagonally lower position from the detection chip 1. Especially, the excitation light source 44 is arranged so that the excitation light emitted therefrom is incident obliquely on the carrier 9 (antibody-immobilized bead) of the detection chip 1 with a small incident angle. The Fresnel lens 18 arranged at the first substrate 11 of the detection chip 1 has substantially the same diameter as that of the excitation light when it passes the Fresnel lens 18 after emitted from the excitation light source 44. The Fresnel lens 18, which functions as a convex lens, is arranged so that the excitation light is deflected with the carrier 9 (antibody-immobilized bead) of the detection chip 1 and is incident on it with a sharper angle.

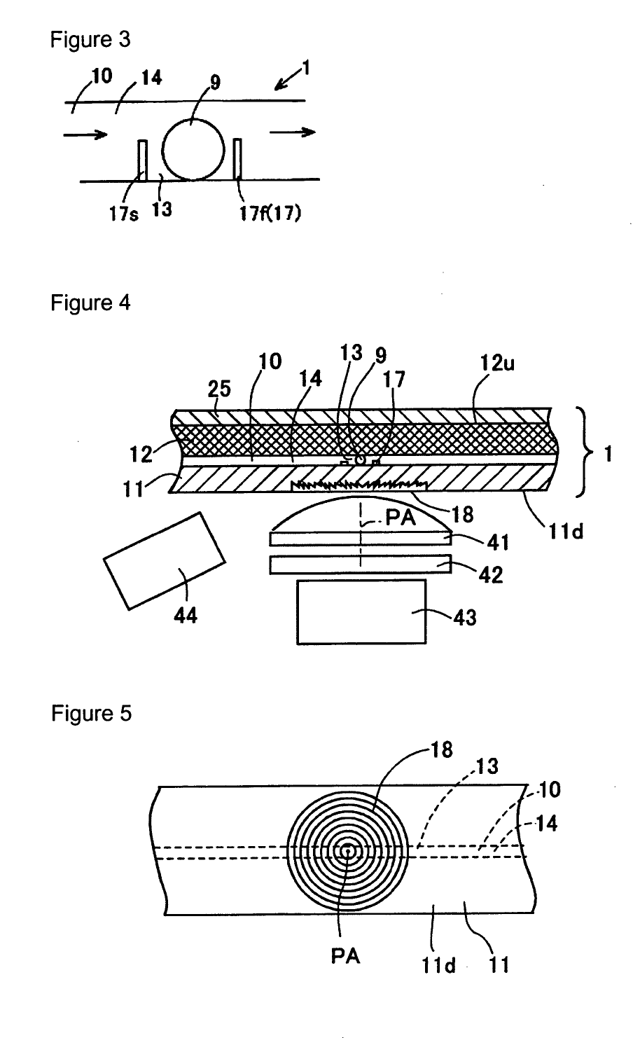

Furthermore, a single carrier 9 supporting the antibody (antibody-immobilized bead) is shown for convenience in FIG. 2, FIG. 3, FIG. 6, etc., but actually a plurality of carriers 9 (antibody-immobilized beads) (for example, 2 to 50 pieces) are retained in the carrier retention section 13.

Incidentally, the fluorescent light to be detected is feeble. For this reason, it is preferable that, after the excitation light emitted from the excitation light source 44 is incident on the carrier 9 (antibody-immobilized bead) as much as possible, a larger quantity of fluorescent light is focused on the Fresnel lens 18 capable of functioning as the light collection means. Therefore, according to the present embodiment, as shown in FIG. 6, the first stopper 17f and the second stopper 17s, which constitute the stopper 17, are arranged at the first substrate 11 of the detection chip 1 so that the carrier retention section 13 of the detection chip 1 is arranged to be on the extended line of the central axial line PA of the Fresnel lens 18. Therefore, in the detection chip according to the present embodiment, the central axial line PA of the Fresnel lens 18 is arranged to substantially overlap the position of the carrier 9 (antibody-immobilized bead) determined by the stopper 17. Thus, the excitation light emitted from the excited light source is arranged to irradiate the carrier 9 (antibody-immobilized bead) of the detection chip 1 favorably.

Next, the fluorescence intensity detector 4 thus described performs a quantitative measurement as follows. That is, as shown in FIG. 6, an excitation light 44a emitted from the excitation light source 44 transmits through the Fresnel lens 18 of the detection chip 1 and reaches the carrier 9 (antibody-immobilized bead) retained at the microchannel flow channel 10 formed in the detection chip 1. Since the carrier 9 (antibody-immobilized bead) supports a fluorescence-labeled competitive substance, the excited fluorescent light (central wavelength of 655 nm) is emitted from the carrier 9 when the carrier 9 is illuminated with the excitation light. Then, this fluorescent light is received by the fluorescence detector 43 and its fluorescence intensity is detected. Thus, a quantitative evaluation of an object substance is performed.

In this instance, it is preferable to prevent a component of the excitation light received by the fluorescence detector 43 from becoming noise. With regard to this aspect, according to the present embodiment, the excitation light incident obliquely from the excitation light source 44 is changed to have a sharper angle after deflected by the Fresnel lens 18 and propagates to the outside of a detection zone of the fluorescence detector 43. That is, as shown in FIG. 6, an excessive component 44c of the excitation light transmits through the second substrate 12 at the upper side of the detection chip 1 and then is reflected by a reflection layer 25 of the second substrate 12. As a result, the excessive component 44c of the excitation light does not enter the Fresnel lens 18 again and passes through the outside of the detection chip 1 from the first substrate 11 at the bottom side.

And, as shown in FIG. 7, the fluorescent light emitted from the excited carrier 9 (antibody-immobilized bead) with the excitation light source 44 diffuses into the first substrate 11 and the second substrate 12 of the detection chip 1. Then the fluorescent light, through processes of total reflection by the reflection layer 25 etc., enters the Fresnel lens 18 and is deflected more in a focusing direction. According to the present embodiment, in which the reflection lens 25 is provided in the detection chip 1, the feeble fluorescent light can be guided to the Fresnel lens 18 as much as possible and can be made incident on the fluorescence detector 43 after light collection. Especially, the Fresnel lens 18 is installed on the first substrate 11 of the detection chip 1 and is in very close vicinity to the carrier 9 (antibody-immobilized bead). Thus, it is possible to collect the emitted fluorescent light efficiently at the fluorescence detector 43. Then, the fluorescent light emitted from the carrier 9 (antibody-immobilized bead) comes out from the detection chip 1 through the Fresnel lens 18 and transmits through the band-pass filter 42 after deflected so as to be focused further by the curvature of the light collection lens 41. Thus the reflected component of the excitation light reflected by the carrier 9 (antibody-immobilized bead) etc. is eliminated. Then, after passing through the band-pass filter 42, only the fluorescence wavelength component having a predetermined wavelength is incident on the fluorescence detector 43. As described above, the fluorescent intensity is detected by the fluorescence detector 43 and the quantitative measurement of the object substance is performed.

To remove an unreacted substance after the antigen-antibody reaction is carried out, it is desirable to perform washing treatment for the carrier 9 retained in the detection chip 1. In the case of the washing treatment, by flowing a solution such as a buffer solution or the like into the supply flow channel 14 of the microchannel flow channel 10 of the detection chip 1, the unreacted substance remaining at the carrier retention section 13 is removed by washing. In the case of washing treatment, it is preferable to swing or rotate the detection chip 1. During the antigen-antibody reaction, the velocity of the detection chip 1 is assumed to be V1 and during washing treatment, the velocity of the detection chip 1 is assumed to be V2. Then, it is preferable that V1 is slower than V2, that is, that V2 is faster than V1 (V2>V1). With this arrangement, it is possible to carry out the reaction at the detection chip 1 favorably. V2/V1 can be arranged to be 1.1 to 50, or 1.1 to 30.

Furthermore, according to the present embodiment, the antibody is supported by the carrier 9 and the antigen is contained in the buffer solution. But it is not limited to this arrangement. The antigen may be supported by the carrier 9 and the antibody may be contained in the buffer solution.

### Embodiment 2

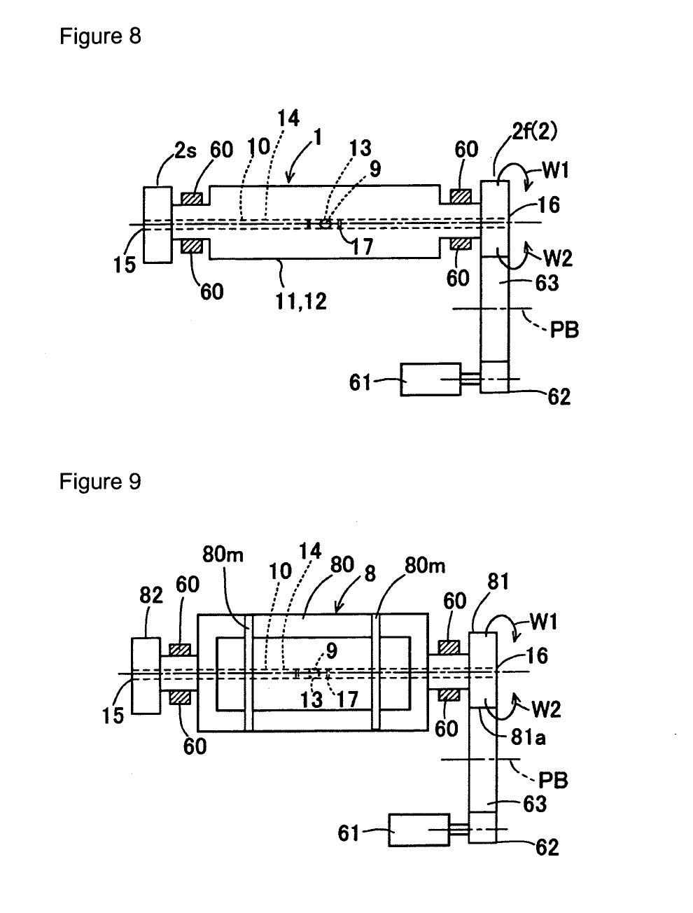

FIG. 8 shows Embodiment 2. The present embodiment has basically a structure and an action effect similar to those of Embodiment 1 described above. Hereinafter, sections different from those of Embodiment 1 will be explained mainly. A detection chip 1 is provided with a shaft-like first protrusion 2f and a shaft-like second protrusion 2s which extend in opposite directions along the longitudinal direction. And, as shown in FIG. 8, a rotating body 63 is provided on the circumferential surface of the first protrusion 2f, and the first protrusion 2f and the second protrusion 2s are supported with a bearing 60 so that it can be rotated. The rotating body 63 rotates around a central axial line PB and functions as a power transmission mechanism. It is made of high polymer materials such as rubber or resins or the like having high friction coefficients or metals. The rotating body 63 is connected to a micro-type driving motor 61 (stepping motor) as an actuator with a down-shift mechanism 62. The down-shift mechanism 62 down-shifts the rotation velocity of the driving motor 61.

During operation, similarly as in the case of Embodiment 1, a predetermined number of bead-like carriers 9 (antibody-immobilized beads) are retained in a carrier retention section 13 of a detection chip 1. In a manner similar to Embodiment 1, an antibody is supported on the surface of the carrier 9 by physical bonding or chemical bonding. The position of the carrier 9 is determined by a stopper 17 and positioning condition of the carrier 9 is maintained favorably at the carrier retention section 13. And, a first substrate 11 is overlaid on a second substrate 12. Under this condition, a buffer solution containing an antigen is supplied from a flow inlet section 15 at the upstream side of a supply flow channel 14 of a microchannel flow channel 10 and is flowed toward a flow outlet section 16 at the downstream side of the microchannel flow channel 10 with a predetermined speed. In this way, an antigen-antibody reaction is carried out. As described above, while the antigen-antibody reaction is carried out on the carrier 9 by flowing the buffer solution toward the downstream side of the microchannel flow channel 10, the micro-type driving motor 61 is operated. In this process, the detection chip 1 is rotated in one direction (W1 arrow direction) or the other direction (W2 arrow direction) continuously. Through this, the detection chip 1 is rotated around the first protrusion 2f and the second protrusion 2s in the one direction (W1 arrow direction) or the other direction (W2 arrow direction). Thus, fluctuations of the antigen-antibody reaction on the carrier 9 are reduced and simultaneously the efficiency of the antigen-antibody reaction is improved. Then, in a manner similar to Embodiment 1, the detection chip 1 is installed for a fluorescence intensity detector 4 and fluorescence intensity is measured.

Also, in the present embodiment, to remove an unreacted substance after the antigen-antibody reaction is carried out, it is preferable to perform washing treatment for the carrier 9 retained in the detection chip 1. In the case of the washing treatment, by flowing a solution such as the buffer solution or the like into the supply flow channel 14 of the microchannel flow channel 10 of the detection chip 1, the unreacted substance remaining at the carrier retention section 13 is removed by washing. In the case of the washing treatment, it is preferable to swing the detection chip 1. The velocity of the detection chip 1 is assumed to be V1 when the antigen-antibody reaction is carried out, and the velocity of the detection chip 1 is assumed to be V2 during the washing treatment. Then it is preferable that V2 is faster than V1 (V2>V1).

### Embodiment 3

FIG. 9 shows Embodiment 3. The present embodiment has basically a structure and an action effect similar to those of Embodiment 1 described above. Hereinafter, sections different from those of Embodiment 1 will be explained mainly. A detection chip 1 has no protrusion such as described above. Equivalence to the protrusion is provided at the holder 8. The holder 8 comprises a supporting surface 80 on which the detection chip 1 is placed after being fixed by a holding member 80m, and a shaft-like first protrusion 81 and a shaft-like second protrusion 82 which extend in opposite directions each other. Then, the first protrusion 81 and the second protrusion 82 are supported with a bearing 60, and a rotating body 63 is provided on the circumferential surface 81a of the first protrusion 81. The rotating body 63 is made of high polymer materials such as rubber or resins or the like having high friction coefficients or metals. The rotating body 63 is connected to a micro-type driving motor 61 (stepping motor) as an actuator with a down-shift mechanism 62.

During use, a predetermined number of bead-like carriers 9 are retained in a carrier retention section 13 of a first substrate 11 of the detection chip 1. On the surface of the carrier 9 either one of an antibody and an antigen is supported by physical bonding or chemical bonding.

Under this condition, a buffer solution containing the other one of the antibody and the antigen is flowed toward a flow outlet section 16 at the downstream side of the microchannel flow channel 10 of the detection chip 1. Thus, an antibody-antigen reaction is carried out. While the antibody-antigen reaction is carried out on the carrier 9 by flowing the buffer solution toward the downstream side of the microchannel flow channel 10 of the detection chip 1, the driving motor 61 is operated. Thus, the detection chip 1 is rotated in one direction (W1 arrow direction) or the other direction (W2 arrow direction). And then, the detection chip 1 is rotated in the one direction (W1 arrow direction) or the other direction (W2 arrow direction) around a first protrusion 81 and a second protrusion 82. Thus, since the carrier 9 retained in the carrier retention section 13 is moved, fluctuations of the antibody-antigen reaction are reduced and, as a result, the efficiency of the antibody-antigen reaction is improved. Thereafter, in a manner similar to Embodiment 1, the detection chip 1 is installed in a fluorescence intensity detector 4 and fluorescence intensity is measured.

### Embodiment 4

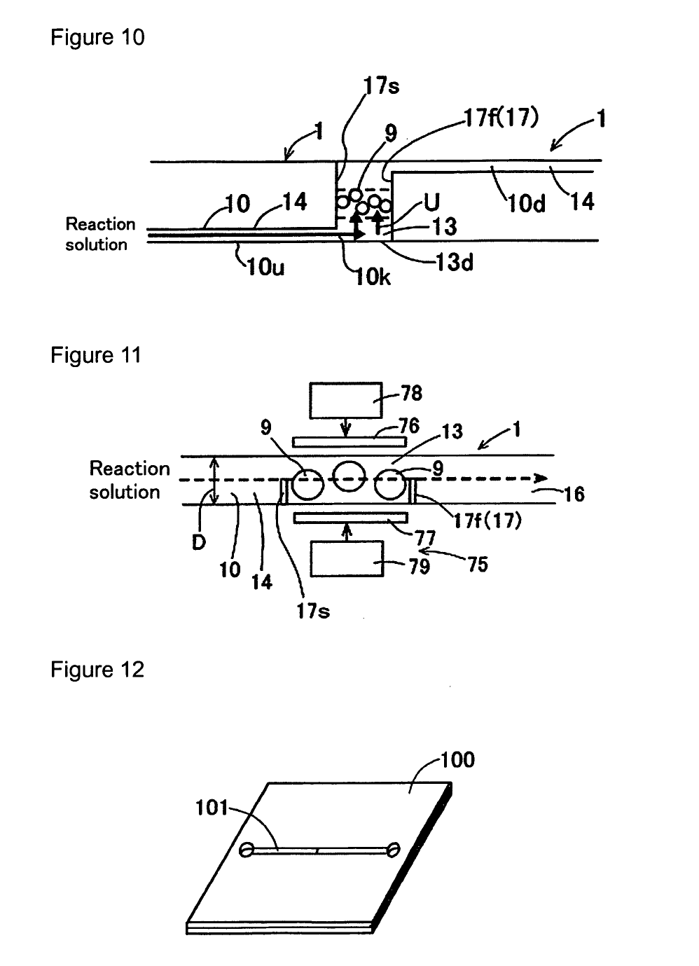

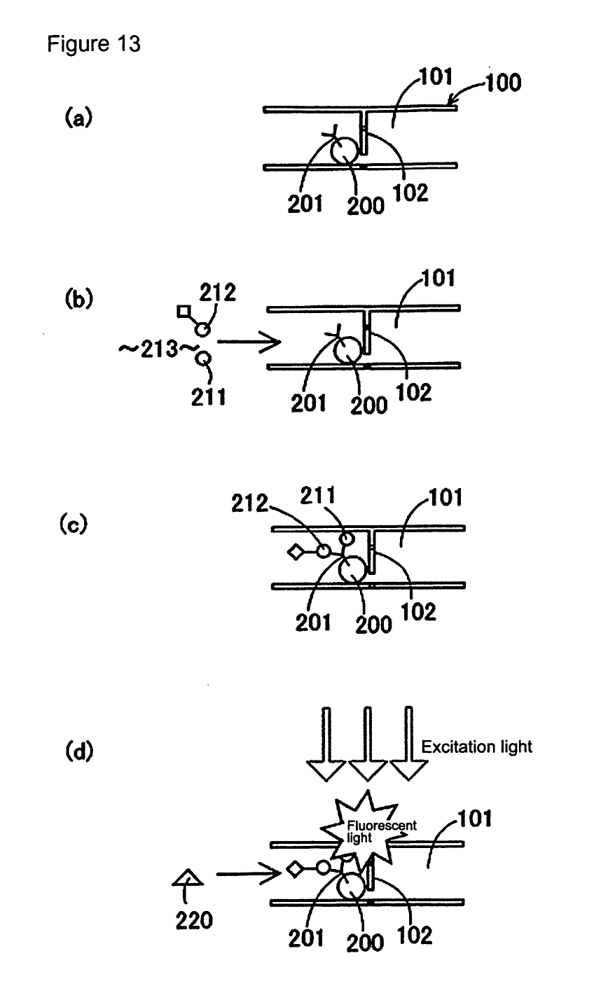

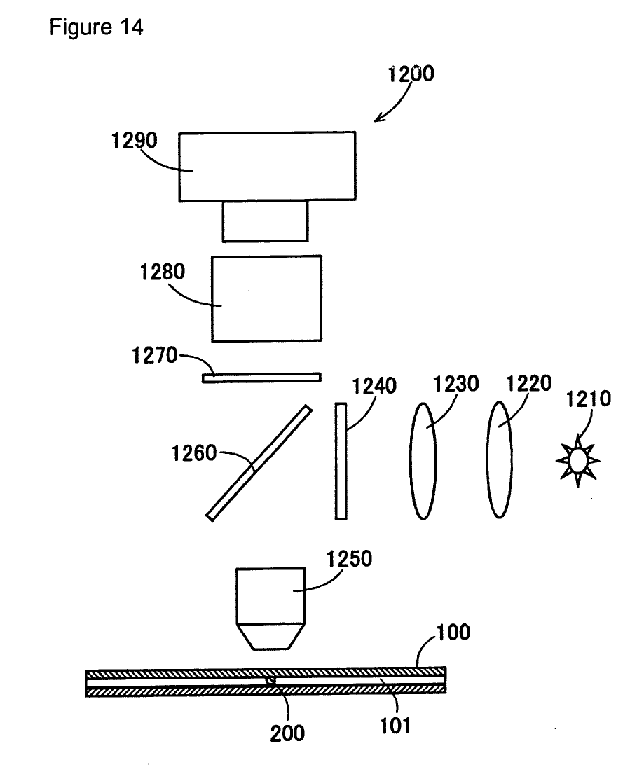

FIG. 10 shows Embodiment 4. The present embodiment has a structure and an action effect basically similar to those of Embodiment 1 described above. Hereinafter, sections different from those of Embodiment 1 will be explained mainly. A carrier mobilization means comprises a liquid means which moves a carrier 9 retained in a carrier retention section 13 with kinetic energy of the liquid. As shown in FIG. 10, the liquid means constitutes an upstream side 10u provided at the upstream from the carrier retention section 13 of a microchannel flow channel 10 at the bottom side of the detection chip 1 and at the same time constitutes a downstream side 10d from the carrier retention section 13 of the microchannel flow channel 10 at the top side of the detection chip 1.

And, a carrier 9 supporting either one of an antibody and an antigen is retained in the carrier retention section 13 of the detection chip 1. Under this condition, a reaction liquid as a solution containing the other one of the antibody and the antigen is supplied to the microchannel flow channel 10 of the detection chip 1 and released in the upward direction at the carrier retention section 13 from an opening 10k. Thus, the carrier 9 (antibody-immobilized bead) retained in the carrier retention section 13 is lifted upward against its own weight (U arrow direction). As described above, during reaction time, the carrier 9 retained in the carrier retention section 13 is moved, and the carrier 9 is prevented from precipitating. As a result, fluctuations of an antigen-antibody reaction are reduced and the efficiency of the antigen-antibody reaction is improved. Thereafter, in a manner similar to Embodiment 1, the detection chip 1 is installed in a fluorescence intensity detector 4 and fluorescence intensity is measured.

### Embodiment 5

FIG. 11 shows Embodiment 5. The present embodiment has a structure and an action effect basically similar to those of Embodiment 1 described above. Hereinafter, sections different from those of Embodiment 1 will be explained mainly. A carrier 9 retained at a carrier retention section 13 of a detection chip 1, which is made of magnetic materials, is a magnetic bead, and a surface thereof supports either one of an antibody and an antigen. A carrier mobilization means comprises a magnetic field generating means 75 which moves the carrier 9 retained in the carrier retention section 13 with magnetic energy. The magnetic field generating means 75 comprises a first magnetic section 76 and a second magnetic section 77 which are provided at both sides of the carrier retention section 13 by sandwiching the carrier retention section 13 in the width direction of a microchannel flow channel (D arrow direction), a first magnetic excitation section 78 which excites the first magnetic section 76, and a second magnetic excitation section 79 which excites the second magnetic section 77.

Under this condition, a reaction solution, which is a buffer solution containing the other one of the antibody and the antigen, is flowed toward a flow outlet section 16 at the downstream side of a microchannel flow channel 10 of a detection chip 1 with a predetermined flow velocity. Thus, an antigen-antibody reaction is carried out on the carrier 9. While the antigen-antibody reaction is carried out on the carrier 9 by flowing a buffer solution toward the downstream side of the microchannel flow channel 10 in this way, the direction of an excitation current flowing in the first magnetic excitation section 78 and the second magnetic excitation section 79 is changed and magnetic polarities of the first magnetic section 76 and the second magnetic section 77 are changed alternately. As a result the carrier can be moved in the width direction (D arrow direction) of the carrier retention section 13. Fluctuations of the antigen-antibody reaction are reduced and at the same time the efficiency of the antigen-antibody reaction is improved.

### TEST EXAMPLE

Next, a test example will be explained. A plurality of beads (carrier diameter of 1 to 3 micrometers), which were physically bonded with biotinylated-IgG antibody, a bio-related material used as a model substance, were filled in a carrier retention section 13 of a detection chip 1. Then, a buffer solution containing fluorescein-labeled streptavidin is supplied to the carrier retention section 13 of the detection chip 1 and a reaction was carried out at room temperature. In this case, the flow velocity of the buffer solution was set at 1 microliter/min. In the test example, during an antigen-antibody reaction, the detection chip 1 was rotated continuously at 5 rpm for 10 minutes. On the other hand, during the antigen-antibody reaction in a comparison example, the detection chip 1 was not rotated and was set to be stationary. Conditions such as the number of beads etc. were set to be the same in the comparison example and the test example.

Next, with regard to washing treatment, a buffer solution (PBS buffer solution) of 50 microliter/min was flowed in a supply flow channel 14 of a microchannel flow channel of the detection chip 1 and an unreacted substance remaining in the carrier retention section 13 was removed by washing at room temperature. In the case of the washing treatment of the test example, the detection chip 1 was rotated continuously at 50 rpm for 10 minutes. That is, when the velocity of the detection chip 1 is assumed to be V1 during the antigen-antibody reaction and if when the velocity of the detection chip 1 is assumed to be V2 during the washing treatment, then V2>V1 and V2/V1=10.

On the other hand, in the comparative example, the detection chip was not rotated and was set to be stationary. Fluorescence intensity was measured in both the test example and the comparative example. The fluorescence intensity was 54,123 in the test example and 41,589 in the comparison example. Thus, it was confirmed that S/N ratio of the test example was improved by about 30% compared to that of the comparison example, and thus it was confirmed that the reaction efficiency was improved.

Note

The present invention is not limited only to the embodiments described above, but it is to be understood that changes and variations may be made without departing from the spirit or scope of the contents. A carrier mobilization means can be integrated in a luminescence intensity detector.

### INDUSTRIAL APPLICABILITY

The present invention can be utilized in a microchannel chip system.

What is claimed is:

1. A microchannel chip system comprising a detection chip having a microchannel flow channel which is provided with a carrier retention section capable of retaining a carrier supporting a second chemical substance which generates a signal by reacting with a first chemical substance and a supply flow channel which supplies a liquid material containing the first chemical substance to the carrier retention section, and a carrier mobilization means which enhances the reactivity of the second chemical substance supported on the carrier with the first chemical substance contained in the liquid material by move the carrier retained in the carrier retention section.

2. The microchannel chip system according to claim 1, wherein a signal detection means is provided for detection of the signal generated from the carrier retained in the detection chip based on the above-described reaction.

3. The microchannel chip system according to claim 2, wherein the signal detection means detects an optical signal generated from the carrier retained in the detection chip.

4. The microchannel chip system according to claim 3, wherein the optical signal is a fluorescence signal.

5. The microchannel chip system according to claim 3, wherein a light collection means is provided for light collection of the optical signal.

6. The microchannel chip system according to claim 5, wherein the light collection means is a Fresnel lens provided integrally in the detection chip.

7. The microchannel chip system according to claim 2, wherein the signal detection means detects at least one signal selected from a group consisting of a magnetic signal, an electrical signal, and a thermal signal generated from the carrier retained in the detection chip.

8. The microchannel chip system according to claim 1, wherein the carrier mobilization means is composed of a protrusion provided at the detection chip or a holder holding the detection chip.

9. The microchannel chip system according to claim 1, wherein the carrier mobilization means is provided with an actuator which moves the detection chip or the holder holding the detection chip.

10. The microchannel chip system according to claim 9, wherein the actuator is a motor mechanism.

11. The microchannel chip system according to claim 1, wherein the carrier mobilization means is composed of a liquid means which moves the carrier retained in the carrier retention section of the detection chip with kinetic energy of a liquid.

12. The microchannel chip system according to claim 11, wherein the liquid means is composed of a release flow channel which moves the carrier retained in the carrier retention section by releasing the liquid material into the carrier retention section, capable of retaining the carrier, of the detection chip.

13. The microchannel chip system according to claim 12, wherein the microchannel flow channel comprises an upstream section which is located at the upstream side of the carrier retention section and formed at the lower side from the carrier retention section and a downstream section which is located at the downstream side of the carrier retention section and formed at the upper side from the carrier retention section.

14. The microchannel chip system according to claim 1, wherein a washing treatment means is provided for removal of an unreacted substance after a reaction between the first chemical substance and the second chemical substance is completed.

15. The microchannel chip system according to claim 14, wherein the washing treatment means is to flow the liquid material into the microchannel flow channel.

16. The microchannel chip system according to claim 15, wherein the carrier mobilization means moves the carrier while the washing treatment means is operated.

17. The microchannel chip system according to claim 16, wherein the velocity of the detection chip during operation of the washing treatment means is faster than the velocity of the detection chip during the reaction between the first chemical substance and the second chemical substance.

18. The microchannel chip system according to claim 1, wherein the carrier mobilization means is composed of a magnetic field generating means which moves the carrier retained in the carrier retention section of the detection chip with magnetic energy.

19. The microchannel chip system according to claim 1, wherein the carrier is at least one selected from a group consisting of resin, ceramics, charcoal, clay, cellulose, silica gel, glass, and collagen.

20. A detection chip having a microchannel flow channel which is provided with a carrier retention section capable of retaining a carrier supporting a second chemical substance which generates a signal by reacting with a first chemical substance and a supply flow channel which supplies a liquid material containing the first chemical substance into the carrier retention section, wherein the detection chip is provided with a carrier mobilization means which enhances the reactivity of the second chemical substance supported in the carrier with the first chemical substance contained in the liquid material by moving the carrier retained in the carrier retention section.
